(19) United States
(12) Patent Application Publication
(10) Pub. No.: US 2026/0204810 A1
(43) Pub. Date: Jul. 16, 2026

(54) TERMINAL AND CONNECTOR

(71) Applicant: SUMITOMO WIRING SYSTEMS, LTD., Mie (JP)

(72) Inventor: Ryuto OKUNADA, Mie (JP)

(21) Appl. No.: 19/440,913

(22) Filed: Jan. 6, 2026

(30) Foreign Application Priority Data
Jan. 14, 2025 (JP) 2025-004744

(51) Int. Cl. H01R 4/48; H01R 4/60

(52) U.S. Cl. CPC H01R 4/4811; H01R 4/484; H01R 4/60

(57) ABSTRACT

A terminal includes a tubular part into which a mating terminal is inserted, and a spring piece that contacts the mating terminal on the inner side the tubular part. The tubular part and the spring piece are integrally formed with each other from a single plate material by press working. The tubular part has an opening part formed to pass through from an inner peripheral surface to an outer peripheral surface in the tubular part. The spring piece is formed to extend from an edge portion of the opening part.

### CROSS-REFERENCE TO RELATED APPLICATIONS

This application is based on and claims priority from Japanese Patent Application No. 2025-004744, filed on January 14, 2025, with the Japan Patent Office, the disclosure of which is incorporated herein in its entirety by reference.

### TECHNICAL FIELD

The present disclosure relates to a terminal and a connector.

### BACKGROUND ART

A terminal described in JP 2024-021632 A, for example, includes a hollow box-shaped conductor part and contact-forming fittings that are conductively fastened to the box-shaped conductor part. The contact-forming fittings and the box-shaped conductor part are press-molded separately and then fastened together by welding or the like. The contact-forming fittings each include a spring piece that extends on the inside of the box-shaped conductor part. An electrical connection between the terminal and a mating terminal is established, by the spring pieces of the contact-forming fittings elastically contacting the mating terminal inserted into the box-shaped conductor part.

### SUMMARY

With a terminal such as the above, a process of fastening the box-shaped conductor part to the contact-forming fittings by welding or the like is needed, and thus the complexity of the manufacturing process is an issue.

An object of the present disclosure is to provide a terminal and a connector that enable a manufacturing process to be simplified.

A terminal of the present disclosure includes a tubular part configured to have a mating terminal inserted therein, and a spring piece configured to contact the mating terminal on an inside of the tubular part, the tubular part and the spring piece being integrally formed with each other from a single plate material by press working, the tubular part having an opening part formed to pass through from an inner peripheral surface to an outer peripheral surface of the tubular part, and the spring piece being formed to extend from an edge portion of the opening part.

According to a terminal and a connector of the present disclosure, it becomes possible to simplify the manufacturing process of the terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of an embodiment.

FIG. 2 is an exploded perspective view of the connector in the embodiment.

FIG. 3 is a cross-sectional view of the connector in the embodiment.

FIG. 4 is a descriptive diagram for describing the terminal in a development state.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Disclosure

First, embodiments of the present disclosure will be listed and described.

[1] A terminal of the present disclosure includes: a tubular part configured to have a mating terminal inserted therein, and a spring piece configured to contact the mating terminal on an inside of the tubular part, the tubular part and the spring piece being integrally formed with each other from a single plate material by press working, the tubular part having an opening part formed to pass through from an inner peripheral surface to an outer peripheral surface of the tubular part, and the spring piece being formed to extend from an edge portion of the opening part.

According to this configuration, the tubular part and the spring piece are integrally formed with each other from a single plate material by press working, and thus a process such as welding a separate spring piece to the tubular part is not required, and, as a result, it becomes possible to simplify the manufacturing process of the terminal. Also, the spring piece that contacts the mating terminal extends from an edge portion of an opening part formed to pass through from the inner peripheral surface to the outer peripheral surface of the tubular part. It thereby becomes possible to improve the yield, compared to a configuration in which a spring piece extending from an end portion of the tubular part bends back on itself on the inside of the tubular part.

[2] In [1] above, the tubular part may include a pair of wall parts opposing each other, a pair of the opening part, each formed in a different one of the wall parts, and a pair of the spring piece, each extending from an edge portion of a different one of the opening parts and opposing each other, and the mating terminal may be inserted between the pair of spring pieces.

According to this configuration, an electrical connection is established between the mating terminal and each spring piece, as a result of the pair of spring pieces contacting the mating terminal so as to sandwich the mating terminal therebetween.

[3] In [1] or [2] above, the spring piece may be set to be at least partially thinner in plate thickness than the tubular part.

According to this configuration, by making the spring pieces thin to improve the elasticity of the spring pieces, it becomes possible to improve the ability of the spring pieces to track the mating terminal. Also, by making at least part of the tubular part thicker than the spring pieces, it becomes possible to handle large currents.

[4] In [3] above, the tubular part may include a thin plate part formed around an entire circumferential direction of the tubular part, and a thick plate part that is thicker in plate thickness than the thin plate part, and the spring pieces may be formed entirely in the thin plate part.

According to this configuration, the spring pieces are entirely included in the thin plate part formed around the entire circumferential direction of the tubular part, and thus the spring pieces can be formed to have a thin plate thickness, and, as a result, the spring pieces flex easily.

[5] A connector of the present disclosure includes the terminal according to any of [1] to [4] above, and a housing having a cavity housing the terminal.

According to this configuration, the tubular part and the spring pieces are integrally formed with each other from a single plate material by press working, and thus a process such as welding the spring pieces to the tubular part is not required, and, as a result, it becomes possible to simplify the manufacturing process of the terminal. Also, the spring pieces that contact the mating terminal each extend from an edge portion of the opening part formed to pass through from the inner peripheral surface to the outer peripheral surface of the tubular part. It thereby becomes possible to improve the yield, compared to a configuration in which a spring piece extending from the end of the tubular part bends back on itself on the inside of the tubular part.

### Detailed Description of Embodiments of Disclosure

Specific examples of a terminal and a connector of the present disclosure will be described below with reference to the drawings. In the diagrams, part of the configuration may be shown in an exaggerated or simplified manner for convenience of description. Also, the dimensional ratios of various portions may differ between diagrams. The diagrams illustrate X, Y, and Z axes that are orthogonal to each other. The front-rear direction of the terminal is along the X axis, and the diagrams illustrate forward X1 which is along the X axis and rearward X2 which is toward the opposite side thereto. The width direction of the terminal is along the Y axis. The height direction of the terminal is along the Z axis, and diagrams illustrate an up direction Z1 which is one side in the height direction along the Z axis, and a down direction Z2 which is toward the opposite side. Note that the terminal is not necessarily used with the up direction Z1 pointing skyward.

Herein, "orthogonal" is not only strictly orthogonal and may also include generally orthogonal within a range that achieves the operation and effect of the present embodiment. "Tubular" as used in the description herein includes not only a shape with a peripheral wall formed continuously around the entire circumferential direction, but also a shape obtained by combining a plurality of parts to form a tubular shape, and a shape that is partially cut out in the peripheral direction such as a C-shape. A "tubular" outer peripheral shape includes, but is not limited to, a circular shape, an elliptical shape, and a polygonal shape with pointed or rounded corners. "Tubular" is a shape having a through hole in plan view, and includes shapes whose outer peripheral shape is the same as the inner peripheral shape of the through hole, and shapes whose outer peripheral shape differs from the inner peripheral shape of the through hole. "Tubular" includes a shape having a predetermined length extending in an axial direction in which a central axis that passes through the center of the through hole extends, and may be any length. Also, "opposing" herein refers to two surfaces or members being positioned in front of each other, and includes not only the case where the two portions are perfectly in front of each other, but also the case where the two portions are partially in front of each other. Also, "opposing" herein includes both the case where another member different from the two portions is interposed between the two portions, and the case where another member is not interposed between the two portions. Also, terms such as "first" and "second" herein are simply used to distinguish between objects, and do not rank objects. The present invention is not limited to these illustrative examples and is indicated by the claims, and all changes that come within the meaning and range of equivalency of the claims are intended to be embraced therein.

### Configuration of Connector 10

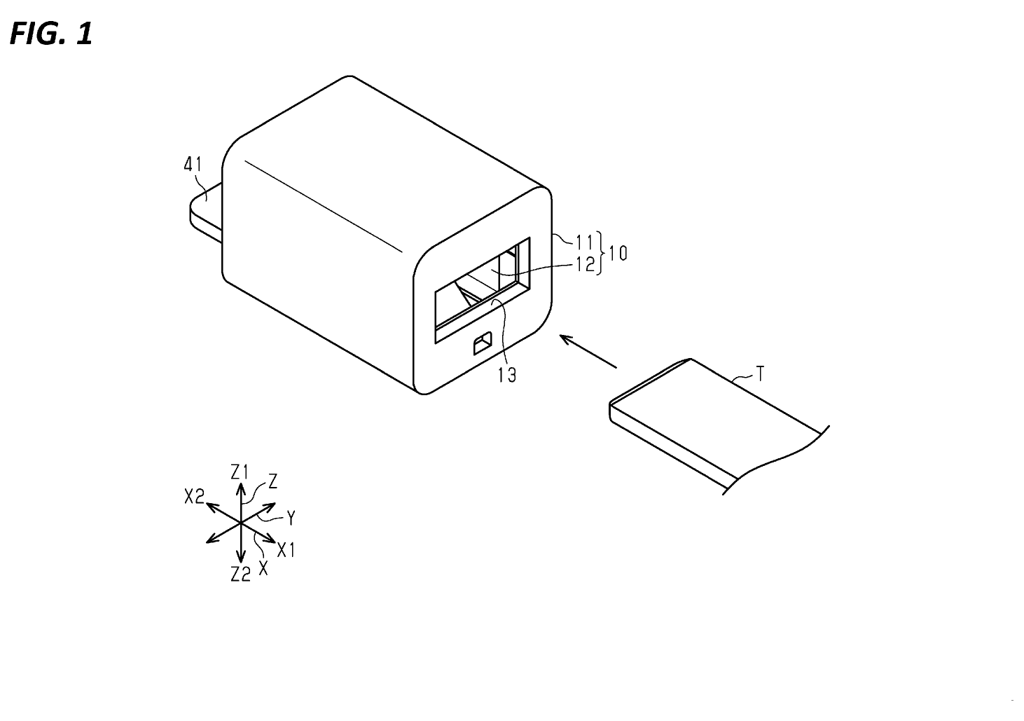

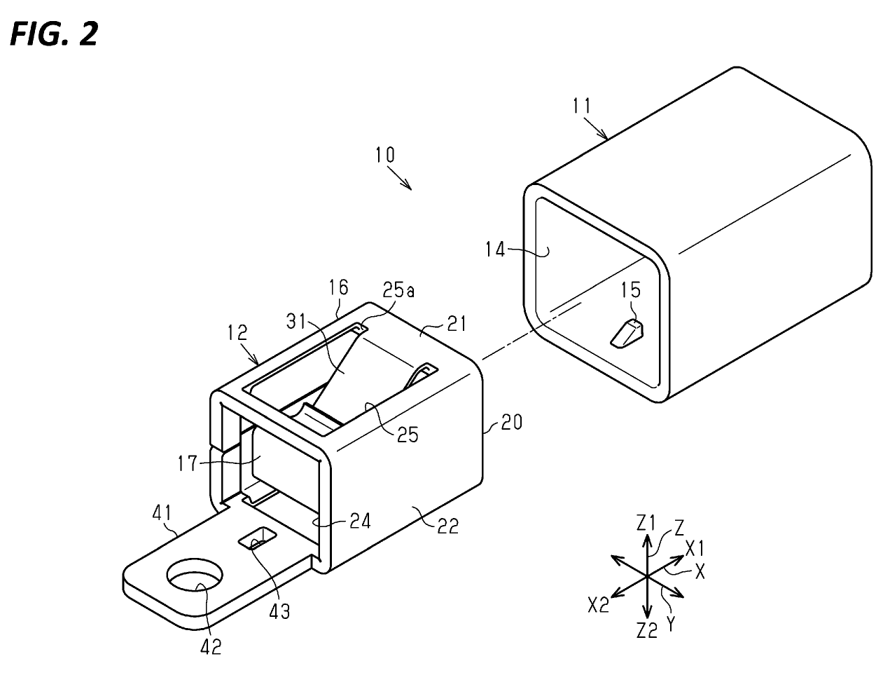

As shown in FIGS. 1 and 2, a connector 10 includes a housing 11 and a terminal 12 housed in the housing 11. The connector 10 is a high-voltage connector capable of handling high voltages and large currents, for example. The connector 10 is configured to be mated to a mating connector (not shown). The terminal 12 of the connector 10 is configured to be connected to a mating terminal T of the mating connector. On the end face on the forward X1 side of the housing 11, an opening 13 into which the mating terminal T is inserted toward the rearward X2 side is provided. The mating terminal T is inserted into the terminal 12 of the connector 10 inside the housing 11.

### Configuration of Housing 11

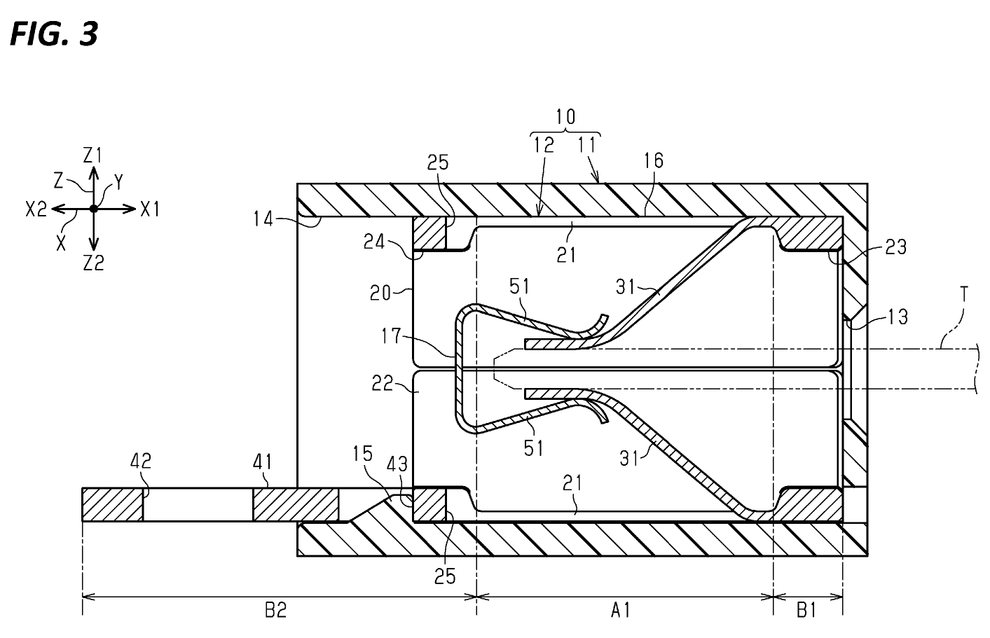

As shown in FIGS. 2 and 3, the housing 11 includes a cavity 14 that houses the terminal 12. The mating terminal T is inserted into the cavity 14 through the aforementioned opening 13. The terminal 12 is assembled toward the forward X1 side from the end portion of the cavity 14 on the rearward X2 side. The cavity 14 includes a locking part 15 that protrudes from the inner surface of the cavity 14. The locking part 15 is locked to the terminal 12 such that the terminal 12 does not come out of the cavity 14 on the rearward X2 side.

### Configuration of Terminal 12

The terminal 12 of the present embodiment includes, for example, a terminal body 16 and a clip 17 that is separate from the terminal body 16.

### Configuration of Terminal Body 16

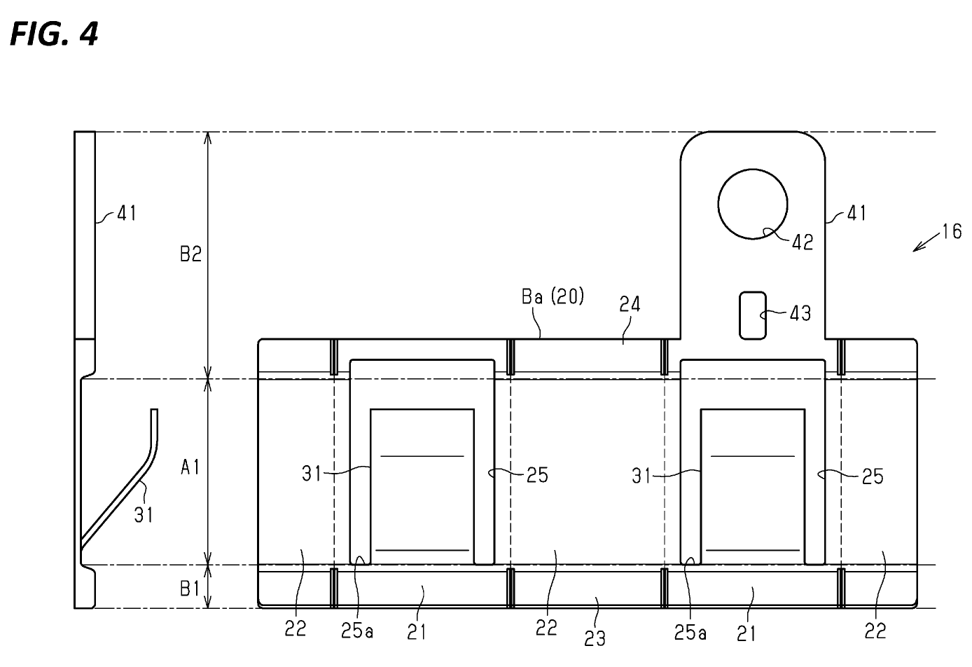

The terminal body 16 includes a tubular part 20 into which the mating terminal T is inserted, a spring piece 31 that contacts the mating terminal T on the inside of the tubular part 20, and a connecting part 41 that is connected to a conductor such as a busbar (not shown). The tubular part 20, the spring piece 31, and the connecting part 41 included in the terminal body 16 are integrally formed with each other from a single metal plate by press working, for example (see FIG. 4).

The tubular part 20 has, for example, a square tubular shape when viewed in the X-axis direction. That is, the tubular part 20 includes a pair of first wall parts 21 that oppose each other in the Z-axis direction and a pair of second wall parts 22 that oppose each other in the Y-axis direction.

As shown in FIG. 3, the tubular part 20 has a terminal insertion opening 23 in a front end portion (end portion on forward X1 side) of the tubular part 20. The terminal insertion opening 23 is formed at the front end portion of each of the first wall parts 21 and the second wall parts 22. In the terminal insertion opening 23, the mating terminal T is inserted toward the rearward X2 side. As shown in FIGS. 2 and 3, the tubular part 20 has a rear end opening part 24 in a rear end portion (end portion on rearward X2 side) of the tubular part 20.

The tubular part 20 has an opening part 25 in each first wall part 21. The opening part 25 is a hole that passes through the first wall parts 21 in a thickness direction (Z-axis direction in the present embodiment) thereof. That is, the opening part 25 is formed to pass through from the inner peripheral surface to the outer peripheral surface of the tubular part 20. The opening part 25 is open in a direction (Z-axis direction in the present embodiment) orthogonal to the axis (straight line along X axis) of the tubular part 20.

### Configuration of Spring Piece 31

The terminal body 16 has two spring pieces 31, for example. Specifically, the spring piece 31 is formed on each of the first wall parts 21 forming a pair. The spring piece 31 is formed to extend from an edge portion 25a (see FIG. 2) on the forward X1 side of the opening part 25 of the first wall part 21. The spring pieces 31 incline so as to approach each other while extending toward the rearward X2 side from the edge portion 25a on the forward X1 side of the opening part 25. The opening parts 25 are provided at the same position as each other when viewed in the Z-axis direction. The spring pieces 31 opposite each other in the Z-axis direction. The mating terminal T is inserted between the pair of spring pieces 31.

### Configuration of Connecting Part 41

The connecting part 41 of the terminal body 16 extends toward the rearward X2 side from a rear end portion of the tubular part 20. The connecting part 41 extends, for example, from one of the first wall parts 21 of the tubular part 20. A conductor such as a busbar to be connected to the connecting part 41, for example, is connected thereto by bolting. The connecting part 41 has an insertion hole 42 through which a bolt (not shown) is inserted, and a locking hole 43 in which the locking part 15 of the housing 11 is locked.

### Configuration of Thin Plate Part A1 and First and Second Thick Plate Parts B1 and B2

As shown in FIG. 3, the terminal body 16 has a thin plate part A1 in a partial area thereof in the X-axis direction, and a first thick plate part B1 and a second thick plate part B2 in areas other than the thin plate part A1 in the X-axis direction.

In the present embodiment, the first thick plate part B1 and the second thick plate part B2 are set to be equal in thickness to each other, and the thin plate part A1 is set to a smaller plate thickness than the first thick plate part B1 and the second thick plate part B2. The terminal body 16 is formed by a specially shaped material with a non-uniform plate thickness.

The thin plate part A1 is formed around the entire circumferential direction of the tubular part 20. Part of the opening parts 25 in the X-axis direction and the entirety of the spring pieces 31 are included in the thin plate part A1. That is, the spring pieces 31 are formed entirely in the thin plate part A1. The plate thickness of the thin plate part A1 is uniform throughout the thin plate part A1 including the spring pieces 31.

The first thick plate part B1 is formed in the area on the tubular part 20 on the forward X1 side of the thin plate part A1. The first thick plate part B1 is formed around the entire circumferential direction of the tubular part 20. The terminal insertion opening 23 of the tubular part 20 is included in the first thick plate part B1.

The second thick plate part B2 is formed in the area of the terminal body 16 on the rearward X2 side of the thin plate part A1. The second thick plate part B2 is partially formed around the entire circumferential direction of the tubular part 20. The entirety of the connecting part 41 of the terminal body 16 is included in the second thick plate part B2.

As shown in FIG. 4, the tubular part 20 of the terminal body 16 is formed by bending a band-shaped part Ba into a tubular shape after press working. Also, in the tubular part 20 formed in a tubular shape, the place where both ends of the band-shaped part Ba oppose each other (i.e., location of the break in the tubular part 20) is constituted to be included in one of the second wall parts 22. In a central part of the band-shaped part Ba in the width direction, the thin plate part A1 is formed to span the entire longitudinal direction of the band-shaped part Ba. The first thick plate part B1 and the second thick plate part B2 are respectively formed on either side of the thin plate part A1 in the width direction. The thin plate part A1 is formed thinner than the first thick plate part B1 and the second thick plate part B2 by pressing, for example. The thin plate part A1 is set to less than half of the plate thickness of the first thick plate part B1 and the second thick plate part B2, for example.

### Configuration of Clip 17

As shown in FIG. 3, the clip 17 is attached to a distal end portion of the pair of spring pieces 31. The clip 17 is formed by press working a metal plate, for example. The clip 17 is separate from the components forming the tubular part 20 including the spring pieces 31. Note that clip 17 does not need to be electrically connected in the terminal 12. Thus, it is possible to use a material or insulator that does not readily conduct electricity for the clip 17. The material of the clip 17 is, for example, stainless steel.

The clip 17 includes a pair of arm parts 51 that sandwich the pair of spring pieces 31. The arm parts 51 incline in a direction approaching each other toward the forward X1 side. The arm parts 51 exhibit a spring force in a direction approaching each other. The spring pieces 31 opposing each other in the Z-axis direction are biased in a direction approaching each other as a result of the elasticity of the clip 17. Any change in the force (contact pressure) of the spring pieces 31 sandwiching the mating terminal T in the Z-axis direction is thereby minimized, even if a positional shift occurs in the Z-axis direction between the terminal 12 and the mating terminal T due to manufacturing tolerance or the like.

### Operation of Embodiment

The following describes the operation of the present embodiment.

The terminal body 16 has the thin plate part A1 including the spring pieces 31 that contact the mating terminal T, and the first thick plate part B1 and the second thick plate part B2 which are greater in plate thickness than the thin plate part A1. The elasticity of the spring pieces 31 is thereby improved, since the spring pieces 31 are formed to have a thin plate thickness, and, as a result, it becomes possible to improve the ability of the spring pieces 31 to track the mating terminal T. Also, large currents can be handled, as a result of the terminal body 16 having the first thick plate part B1 and the second thick plate part B2.

### Effect of Embodiment

The following describes the effect of the present embodiment.

(1) The tubular part 20 and the spring piece 31 are integrally formed with each other from a single plate material by press working, and thus a process such as welding separate spring pieces to the tubular part 20 is not required, and, as a result, it becomes possible to simplify the manufacturing process of the terminal body 16. Also, the spring piece 31 that contacts the mating terminal T extends from the edge portion 25a of the opening part 25 formed to pass through from the inner peripheral surface to the outer peripheral surface of the tubular part 20. It thereby becomes possible to improve the yield, compared to a configuration in which a spring piece 31 extending from an end portion of the tubular part 20 bends back on itself on the inside of the tubular part 20.

(2) The tubular part 20 has the pair of first wall parts 21 opposing each other, the pair of opening parts 25 respectively formed in the pair of first wall parts 21, and the pair of spring pieces 31 respectively extending from the edge portions 25a of the pair of opening parts 25 and opposing each other. The mating terminal T is inserted between the pair of spring pieces 31. According to this configuration, the pair of spring pieces 31 contact the mating terminal T so as to sandwich the mating terminal T therebetween, thus making it possible to increase the contact pressure on the mating terminal T.

(3) The spring pieces 31 are set to be thinner in plate thickness than at least part of the tubular part 20. According to this configuration, by making the spring pieces 31 thin to improve the elasticity of the spring pieces 31, it becomes possible to improve the ability of the spring pieces 31 to track the mating terminal T. Also, by maintaining at least part of the tubular part 20 at the original thickness of the base plate, it becomes possible to handle large currents.

(4) The tubular part 20 has the thin plate part A1 formed around the entire circumferential direction of the tubular part 20, and the first thick plate part B1 and the second thick plate part B2 which are thicker than the thin plate part A1. The spring pieces 31 are formed entirely in the thin plate part A1. According to this configuration, the entirety of the spring pieces 31 is included in the thin plate part A1 formed around the entire circumferential direction of the tubular part 20, and thus the spring pieces 31 can be formed to have a thin plate thickness, and, as a result, the spring pieces 31 flex easily.

(5) The housing 11 has the cavity 14 that houses the terminal 12. That is, the outer circumference of the terminal 12 is covered by the housing 11. Accordingly, the spring pieces 31 can be protected by the housing 11.

### Other Embodiments

Changes such as the following can be made to the above embodiment. The above embodiment and the following example changes may be implemented in combination with each other to the extent that there are no technical inconsistencies therebetween.

A configuration may be adopted in which, in the terminal body 16, only the spring pieces 31 are formed thin, and all parts other than the spring pieces 31 are formed thicker in plate thickness than the spring pieces 31.

The plate thickness may be uniform throughout the entire terminal body 16. That is, the terminal body 16 may not have the thin plate part A1, the first thick plate part B1 and the second thick plate part B2.

In the terminal 12 of the above embodiment, the clip 17 may be omitted.

In the terminal body 16, the opening part 25 and the spring piece 31 may be provided only on one of the first wall parts 21 forming a pair.

In the terminal body 16, the number of spring pieces 31 extending from the edge portion 25a of one opening part 25 is not limited to the above embodiment, and may be two or more.

The thin plate part A1 of the terminal body 16 may be formed thinner than the first thick plate part B1 and the second thick plate part B2 by cutting, for example.

A conductor such as a busbar may be connected to the connecting part 41 of the terminal 12 by welding or the like, for example.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal comprising:
a tubular part configured to have a mating terminal inserted therein; and
a spring piece configured to contact the mating terminal on an inside of the tubular part,
wherein the tubular part and the spring piece are integrally formed with each other from a single plate material by press working,
the tubular part has an opening part formed to pass through from an inner peripheral surface to an outer peripheral surface of the tubular part, and
the spring piece is formed to extend from an edge portion of the opening part.

2. The terminal according to claim 1,
wherein the tubular part includes:
a pair of wall parts opposing each other;
a pair of the opening part, each formed in a different one of the wall parts; and
a pair of the spring piece, each extending from an edge portion of a different one of the opening parts and opposing each other, and
the mating terminal is inserted between the pair of spring pieces.

3. The terminal according to claim 1,
wherein the spring piece is set to be at least partially thinner in plate thickness than the tubular part.

4. The terminal according to claim 3,
wherein the tubular part includes:
a thin plate part formed around an entire circumferential direction of the tubular part; and
a thick plate part that is thicker in plate thickness than the thin plate part, and
the spring piece is formed entirely in the thin plate part.

5. A connector comprising:
the terminal according to claim 1; and
a housing having a cavity housing the terminal.
